(19) United States
(12) Patent Application Publication
(10) Pub. No.: US 2018/0170334 A1
(43) Pub. Date: Jun. 21, 2018

(54) Hydraulic Power Unit of a Brake Control System of a Vehicle Hydraulic Brake System

(71) Applicant: Robert Bosch GmbH, Stuttgart (DE)

(72) Inventors: Michael Loeffler, Oberstaufen (DE); Thomas Zander, Langenargen (DE)

(21) Appl. No.: 15/792,689

(22) Filed: Oct. 24, 2017

(30) Foreign Application Priority Data
Dec. 21, 2016 (DE) 10 2016 225 741.2

(51) Int. Cl. B60T 8/36; B60T 8/40

(52) U.S. Cl. CPC B60T 8/368; B60T 8/404; B60T 8/4022

(57) ABSTRACT

A hydraulic power unit for a slip control system of a vehicle hydraulic brake system includes a hydraulic block that is equipped with hydraulic constructional elements such as hydraulic pumps and solenoid valves of the slip control system and an electric motor that is configured to drive the hydraulic pumps. The power unit further includes hydraulic accumulators attached on the outside on the hydraulic block in a control unit housing arranged next to an electronic control unit of the slip control system in order to save installation space.

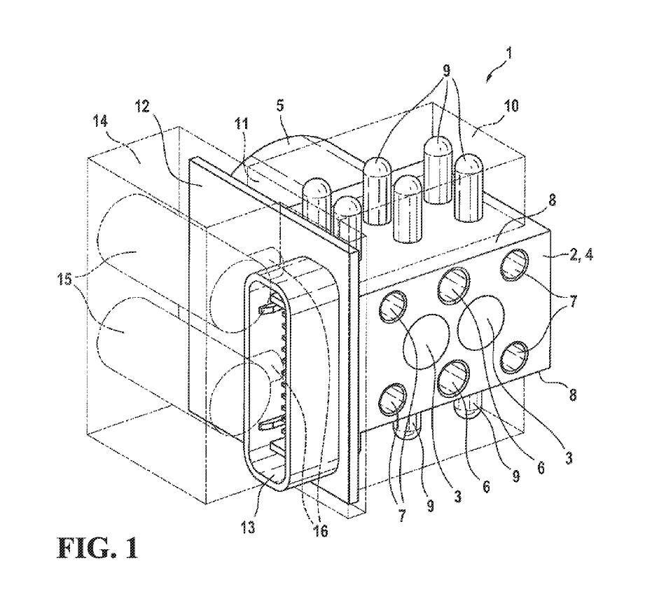

This application claims priority under 35 U.S.C. § 119 to patent application no. DE 10 2016 225 741.2, filed on Dec. 21, 2016 in Germany, the disclosure of which is incorporated herein by reference in its entirety.

### BACKGROUND

The disclosure relates to a hydraulic power unit of a brake control system of a vehicle hydraulic brake system having the features of the disclosure. To be understood by brake control system is a control system of a hydraulic brake pressure or a braking force for, for example, slip control systems and/or powered braking systems. The controlling can be carried out for individual wheels, for groups of wheels, for brake circuits or for the vehicle brake system overall. Such hydraulic power units are known, and are used for slip control systems such as anti-locking control systems, traction slip regulating systems and/or vehicle-dynamics control systems/electronic stability programs in motor vehicles and motorcycles. For slip control systems, the abbreviations ABS, ASR, FDR/ESP are customary. Slip control systems of vehicle hydraulic brake systems are known from automobiles and motorcycles and are not explained in more detail here. Such hydraulic power units can also be used for vehicle powered brake systems with or without slip control.

The principal part of slip control systems of vehicle hydraulic brake systems is a hydraulic power unit which features a hydraulic block which is equipped with hydraulic constructional elements of the slip control system and by means of hydraulic pipes is connected to a master brake cylinder and to which by means of brake pipes hydraulic wheel brakes are connected. Hydraulic constructional elements are inter alia solenoid valves, hydraulic pumps—typically piston pumps,—check valves, hydraulic accumulators, damping chambers and pressure sensors. The hydraulic block is typically a parallelepipedal metal block which serves for mechanical fastening and hydraulic interconnection of the hydraulic constructional elements of the slip control system. Interconnection means a hydraulic connection of the hydraulic constructional elements in accordance with a hydraulic circuit diagram of the slip control system. Equipped with the hydraulic constructional elements and with an electric motor attached to it for driving the hydraulic pump(s) and with an electronic control unit for open-loop or closed-loop control of the electric motor and the solenoid valves in the event of a slip control, the hydraulic block forms the hydraulic power unit.

Unexamined German application DE 10 2006 059 924 A1 discloses an example of a hydraulic block for a slip control system of a vehicle hydraulic brake system. The known hydraulic block has cylindrical blind holes as sockets for hydraulic accumulators of the slip control system, which on account of their necessary volume occupy constructional space inside the hydraulic block.

### SUMMARY

The hydraulic power unit according to the disclosure has a hydraulic block with at least one hydraulic pump and an electric motor for its drive. For each brake circuit of the vehicle brake system the hydraulic block preferably has one or even more hydraulic pumps for a brake pressure build-up and/or for delivering brake fluid. In most cases, the hydraulic pumps are piston pumps, sometimes also (internal) gear pumps, wherein other hydraulic pumps are not excluded. Furthermore, the hydraulic block has valves, especially solenoid valves for brake control. As further hydraulic constructional elements the hydraulic block can have damping chambers and/or pressure sensors. Furthermore, the hydraulic block has connections for one or more hydraulic wheel brakes and can have one or more connections for connection to a master brake cylinder. Such connections are normally blind holes with a female thread for connecting brake pipes which come from a master brake cylinder and/or lead to wheel brakes, with threaded nipples or threadless blind holes for the pressing in of press-in nipples.

The hydraulic block is especially, but not necessarily, a parallelepipedal metal block with sockets into which the hydraulic constructional elements of the slip control system are pressed, screwed or installed in another way. The hydraulic block retains the hydraulic constructional elements mechanically and interconnects them by means of a bore arrangement of the hydraulic block, hydraulically in accordance with a hydraulic circuit diagram of a brake control system. The electric motor is preferably fastened on the hydraulic block on the outside.

An electronic control unit for open-loop or closed-loop control of the electric motor and the valves of the slip control system, together with a control unit housing in which the control unit is accommodated, is arranged on the outside on a side of the hydraulic block which is referred to here as the control unit side of the hydraulic block. For brake control, the electronic control unit receives electrical or electronic signals inter alia from pressure sensors of the brake control system which are accommodated on or in the hydraulic block, and from other pressure sensors and other sensors of the brake control system which are arranged in another location on or in a vehicle which is equipped with a vehicle hydraulic brake system which features the hydraulic power unit according to the disclosure. Other sensors are for example wheel rotation sensors on vehicle wheels and/or pedal travel sensors or piston travel sensors of a master brake cylinder. The electronic control unit open-loop or closed-loop controls controllable valves, or valves which are to be controlled, especially solenoid valves of the brake control system. The hydraulic block can also have uncontrolled valves, for example automatic valves, such as check valves.

According to the disclosure, one or more hydraulic accumulators of the slip control system is/are arranged on the outside on the hydraulic block in the control unit housing on the control unit side of the hydraulic block. As a result, installation space in the hydraulic block is saved and hydraulic accumulators of different sizes can be used without any problem. In particular, one or more hydraulic accumulators is/are provided for each brake circuit. The hydraulic accumulator(s) is/are connected to the bore arrangement of the hydraulic block and are therefore hydraulically interconnected with other hydraulic constructional elements of the brake control system.

The hydraulic power unit according to the disclosure with the equipped hydraulic block serves for brake control of a vehicle hydraulic brake system. Such brake control systems are for example an anti-locking control system, a traction slip regulating system and/or a vehicle dynamics control system/electronic stability program, for which the abbreviations ABS, ASR, FDR/ESP are customary. Further brake control systems such as brake assist or distance assist systems are possible. The hydraulic power unit according to the disclosure can also be used for a vehicle hydraulic powered brake system with or even without an anti-locking control system and similar brake control systems. Equipped means that the hydraulic constructional elements, the electric motor and the electronic control unit are attached on the hydraulic block and in sockets in the hydraulic block. The control unit receives signals from the pressure sensors and from wheel rotation sensors and, if necessary, from further sensors and open-loop or closed-loop controls especially the electric motor, for driving the hydraulic pump(s), and the solenoid valves. Such brake control systems and hydraulic power units for their performance are known and are not explained in more detail here.

The dependent claims involve advantageous embodiments and developments of the disclosure.

### BRIEF DESCRIPTION OF THE DRAWING

The disclosure is explained in more detail below based on an embodiment which is shown in the drawing. The single FIGURE shows a hydraulic power unit according to the disclosure in a perspective view. The drawing is a simplified representation for the explanation and for the comprehension of the disclosure.

### DETAILED DESCRIPTION

The hydraulic power unit 1 according to the disclosure which is shown in the drawing is provided for a brake control system, which in the described embodiment is for a slip control system of a vehicle hydraulic brake system. Such slip control systems are for example anti-locking control systems, traction slip regulating systems and/or vehicle dynamic control systems/electronic stability programs, for which the abbreviations ABS, ASR, FDR/ESP are customary. In general, the hydraulic power unit 1 is provided for a brake control system, which for example can also be an open-loop or closed-loop brake pressure control system and/or an open-loop or closed-loop braking power control system in the case of a powered brake system.

The hydraulic power unit 1 has a parallelepipedal hydraulic block 2 consisting of metal. The hydraulic block 2 is equipped, that is to say it has hydraulic constructional elements of the slip control system such as solenoid valves, check valves, pressure sensors and hydraulic pumps, which are pressed into sockets of the hydraulic block 2 or installed in another way and by means of a bore arrangement of the hydraulic block 2, with connections for hydraulic accumulators and with connections for a master brake cylinder and for hydraulic wheel brakes, are hydraulically interconnected, that is to say are connected in accordance with a hydraulic circuit diagram of the slip control system.

In the described and depicted embodiment, the hydraulic power unit 1 is provided for a vehicle brake system with two brake circuits. Installed in the hydraulic block 2 are two—one for each brake circuit—piston pumps as hydraulic pumps 3. The hydraulic pumps 3, in parallel next to each other, are pressed into diameter-stepped holes as pump sockets in the hydraulic block 2. In the drawing, only the one end faces of the hydraulic pumps 3 in one side of the hydraulic block 2 are visible, which side is referred to here as the connection side 4 of the hydraulic block 2. The hydraulic pumps 3 are arranged in a center plane of the hydraulic block 2. The arrangement of the hydraulic pumps 3 is not mandatory for the disclosure, they can for example also be arranged coaxially opposite each other and radially to an axis of an electric motor which serves for their drive.

For driving the hydraulic pumps 3, an electric motor 5 is arranged on a side of the hydraulic block 2 which is opposite the connection side 4. This side is subsequently referred to as the motor side.

On or in the connection side 4, the hydraulic block 2 has two connections 6 for connecting the hydraulic block 2 of the hydraulic power unit 1 to a dual-circuit master brake cylinder, which is not shown, and four connections 7 for connecting hydraulic wheel brakes, which are not shown, to the hydraulic block 2 or to the hydraulic power unit 1. The connections 6, 7 are cylindrical blind holes for the pressing in of self-sealing press-in nipples for the connection of brake pipes. A connection of the brake pipes for example also using threaded nipples is possible. Three connections 6, 7 are arranged in each case in the hydraulic block 2 on both sides of the hydraulic pumps 3 in two planes which are parallel to the center plane in which the hydraulic pumps 3 are located. The two connections 6 for the master brake cylinder are arranged in the connection side 4 of the hydraulic block 2 in the middle between two connections 7 in each case for wheel brakes. The arrangement of the connections 6, 7 is not mandatory for the disclosure.

Arranged on sides of the hydraulic block 2 which are disposed opposite each other and referred to here as valve sides 8 are solenoid valves 9 of the slip control system. The valve sides 8 adjoin the connection side 4 and the motor side of the hydraulic block 2. On each valve side 8 the hydraulic block 2 has six solenoid valves 9 which are arranged with three solenoid valves 9 in each case in two rows which are parallel to the connection side 4 and to the motor side. Of the solenoid valves 9 only valve domes are visible, which valve domes project outward from the valve sides 8 and in which are located coils and armatures of the solenoid valves 9. The arrangement of the solenoid valves 9 is not mandatory for the disclosure. Hydraulic parts of the solenoid valves 9, i.e. the actual valves, are located in diameter-stepped blind holes which as valve sockets are introduced into the valve sides 8 of the hydraulic block 2 and for this reason are not visible. The solenoid valves 9 or their valve domes are located in box-like valve housings 10 which are arranged on the valve sides 8 of the hydraulic block 2. The valve housings 10 are transparently depicted so that the solenoid valves 9 or the valve domes are visible. The box-like valve housings 10 are open on the side by which they are attached on the hydraulic block 2, and can also be understood as being valve covers.

Arranged on a side of the hydraulic block 2 which is referred to here as the control unit side 11 is an electronic control unit 12. The control unit side 11 adjoins the connection side 4, the motor side and the valve sides 8 of the hydraulic block 2. The electronic control unit 12 has a circuit board which is equipped with electronic components, which are not depicted. The circuit board or the control unit 12 can also have sensors, for example position sensors, acceleration sensors and/or a rotational angle sensor and/or rotational acceleration sensor for a vehicle dynamics control system/electronic stability program, which in everyday language are also referred to as anti-skid control systems. Also arranged on the circuit board of the electronic control unit is a plug-in connector 13 for a power supply of the electronic control unit 12 and of the electric motor 5 and for connecting the electronic control unit 12 to a vehicle electronics system and/or to sensors of a vehicle which has a vehicle hydraulic brake system with the hydraulic power unit 1 according to the disclosure. The electronic control unit 12 receives signals from sensors and open-loop or closed-loop controls the electric motor 5 and the solenoid valves 9 of the slip control system.

The electronic control unit 12 is covered by a housing 14 which is arranged on the control unit side 11 of the hydraulic block 2. The control unit housing 14, which like the valve housing 10 is transparently depicted, is in the form of a box and open on the side which is arranged on the control unit side 11 of the hydraulic block 2, and can also be understood as a control unit cover. The plug-in connector 13 is located outside the control unit housing 14 or is accessible through an opening of the control unit housing 14. A different control unit housing, which is not shown, can also be used and which for example is closed or largely closed and has a significantly smaller opening on the side which is arranged on the control unit side 11 of the hydraulic block 2.

The hydraulic power unit 1 has hydraulic accumulators 15 which are arranged on the outside on the hydraulic block 2 on the control unit side 11 and in the control unit housing 14. For each brake circuit provision is made for a hydraulic accumulator 15, that is to say two in the depicted and described embodiment of the disclosure. The hydraulic power unit 1 can also have more hydraulic accumulators 15 (not shown). The two hydraulic accumulators 15 are arranged parallel next to each other and parallel to the electric motor 5 in the control unit housing 14 on the outside on the control unit side 11 of the hydraulic block 2 and project beyond the motor side of the hydraulic block 2. The hydraulic accumulators 15 do not project in the axial direction beyond an end face of the electric motor 5 facing away from the hydraulic block 2 so that overall a compact construction of the hydraulic power unit 1 is created. Large hydraulic accumulators 15, that is to say long hydraulic accumulators and/or hydraulic accumulators having large diameters, can also be arranged in the control unit housing 14 on the control unit side 11 of the hydraulic block 2 without an installation space of the hydraulic power unit 1 being increased. The arrangement of the hydraulic accumulators 15 parallel to each other and/or parallel to the electric motor 5 is not mandatory for the disclosure, for example a coaxial arrangement of the hydraulic accumulators 15 (not shown) is also possible.

For a hydraulic connection and a mechanical fastening the hydraulic accumulators 15 have connections 16 which project radially close to their one ends, which connections are illustrated in the drawing by means of dashed lines and are depicted in a simplified manner as cylinders without details of a press-in nipple. The connections 16 are designed in the style of self-sealing press-in nipples and are pressed into blind holes in the control unit side 11 of the hydraulic block 2 which form connections of the hydraulic block 2 for the hydraulic accumulators 15.

Equipped with the hydraulic constructional elements of the slip control system, the hydraulic block 2 forms the hydraulic power unit 1 which is the principal part, or a principal part, of the slip control system or generally of a brake control system of a vehicle hydraulic brake system which otherwise is not shown.

What is claimed is:

1. A hydraulic power unit of a brake control system of a vehicle hydraulic brake system, comprising:
a hydraulic block with at least one hydraulic pump;
an electric motor configured to drive the at least one hydraulic pump;
valves configured for brake control;
at least one connection configured for a wheel brake;
an electronic control unit configured for one or more of open-loop control and closed-loop control of the electric motor and the valves;
a control unit housing; and
at least one hydraulic accumulator,
wherein the at least one hydraulic pump, the valves, and the electric motor are mechanically fastened on or in the hydraulic block and the at least one hydraulic pump, the valves, and the at least one connection are hydraulically interconnected by a bore arrangement of the hydraulic block,
wherein the control unit is arranged in the control unit housing and together with the control unit housing is arranged on a control unit side of the hydraulic block, and
wherein the at least one hydraulic accumulator is arranged on the control unit side of the hydraulic block and in the control unit housing, the hydraulic accumulator communicating with the bore arrangement of the hydraulic block and, by way of the bore arrangement of the hydraulic block, the hydraulic accumulator is hydraulically connected to the at least one hydraulic pump and to the valves.

2. The hydraulic power unit as claimed in claim 1, wherein the hydraulic block has a connection on the control unit side for the at least one hydraulic accumulator, the hydraulic accumulator communicating with the bore arrangement of the hydraulic block via the connection on the control unit side.

3. The hydraulic power unit as claimed in claim 1, wherein the electric motor is arranged on a motor side of the hydraulic block which adjoins the control unit side.

4. The hydraulic power unit as claimed in claim 3, wherein the at least one hydraulic accumulator one or more of (i) is arranged parallel to the electric motor and (ii) projects beyond the motor side of the hydraulic block.

5. The hydraulic power unit as claimed in claim 1, wherein the valves are arranged on oppositely disposed valve sides of the hydraulic block.

6. The hydraulic power unit as claimed in claim 5, wherein the valve sides adjoin one or more of the control unit side and the motor side of the hydraulic block.
